(19) United States
(12) Patent Application Publication
(10) Pub. No.: US 2026/0101216 A1
(43) Pub. Date: Apr. 9, 2026

(54) METHOD, DEVICE AND COMPUTER STORAGE MEDIUM OF COMMUNICATION

(71) Applicant: NEC Corporation, Tokyo (JP)

(72) Inventors: Zonghui XIE, Beijing (CN); Gang WANG, Beijing (CN)

(73) Assignee: NEC Corporation, Tokyo (JP)

(21) Appl. No.: 19/115,971

(22) PCT Filed: Sep. 27, 2022
(86) PCT No.: PCT/CN2022/121927

§ 371 Date: Mar. 27, 2025

(51) Int. Cl. H04W 24/10

(52) U.S. Cl. CPC H04W 24/10

(57) ABSTRACT

Embodiments of the present disclosure relate to methods, devices and computer readable media for communication. If measurements for a first cell satisfy a first condition, a terminal device causes the first cell to be comprised in a first list. If the first list satisfies a second condition associated with a set of interested cells, the terminal device transmits a measurement report. In this way, a frequent measurement report may be avoided.

### FIELD

Embodiments of the present disclosure generally relate to the field of telecommunication, and in particular, to methods, devices and computer storage media of communication for a measurement reporting.

### BACKGROUND

For aerial user equipment (UE) such as unmanned aerial vehicle (UAV), if its height is below a network device, its radio characteristic is more like that of UE on the ground, i.e. multipath transmission and limited neighbor interference. If its height is above the network device, its radio characteristic is different from that of UE on the ground, e.g., line of sight transmission and strong neighbor interference. Aerial UE may see more cells with similar signal strength and aerial UE may see more far away cells than a terrestrial UE. In this case, a measurement reporting may be frequently triggered, and interference caused by signaling may be increased.

### SUMMARY

In general, embodiments of the present disclosure provide methods, devices and computer storage media of communication for a measurement reporting.

In a first aspect, there is provided a method of communication. The method comprises: in accordance with a determination that measurements for a first cell satisfy a first condition, causing, at a terminal device, the first cell to be comprised in a first list; and in accordance with a determination that the first list satisfies a second condition, transmitting a measurement report, the second condition being associated with a set of interested cells.

In a second aspect, there is provided a method of communication. The method comprises: in accordance with a determination that measurements for a first cell satisfy a first condition, causing, at a terminal device, the first cell to be comprised in a first list; in accordance with a determination that measurements for a second cell in the first list satisfy a third condition, causing the second cell to be comprised in a second list; and in accordance with a determination that the second list satisfies a fourth condition, transmitting a measurement report.

In a third aspect, there is provided a method of communication. The method comprises: in accordance with a determination that measurements for a beam of a third cell satisfy a fifth condition, causing, at a terminal device, the beam to be comprised in a third list; and in accordance with a determination that the third list satisfies a sixth condition, transmitting a measurement report.

In a fourth aspect, there is provided a method of communication. The method comprises: determining, at a terminal device, an eighth condition based on at least one of beam measurements or a height of the terminal device; and in accordance with a determination that measurements for a fourth cell satisfy the eighth condition, causing the fourth cell to be comprised in a fifth list for triggering a measurement report.

In a fifth aspect, there is provided a device of communication. The device comprises a processor configured to perform the method according to any of the first to fourth aspects of the present disclosure.

In a sixth aspect, there is provided a computer readable medium having instructions stored thereon. The instructions, when executed on at least one processor, cause the at least one processor to perform the method according to any of the first to fourth aspects of the present disclosure.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which some embodiments of the present disclosure can be implemented;

FIG. 2 illustrates a schematic diagram illustrating a process of communication for a measurement reporting according to some embodiments of the present disclosure;

FIG. 3A illustrates a schematic diagram illustrating an example process of a measurement reporting based on a set of interested cells according to some embodiments of the present disclosure;

FIG. 3B illustrates a schematic diagram illustrating an example process of a measurement reporting based on a weight of a cell according to some embodiments of the present disclosure;

FIG. 3C illustrates a schematic diagram illustrating an example process of a measurement reporting based on quality of a cell according to some embodiments of the present disclosure;

FIG. 4 illustrates a schematic diagram illustrating another process of communication for a measurement reporting according to some embodiments of the present disclosure;

FIG. 5A illustrates a schematic diagram illustrating an example process of a measurement reporting based on a leaving cell list according to some embodiments of the present disclosure;

FIG. 5B illustrates a schematic diagram illustrating another example process of a measurement reporting based on a leaving cell list according to some embodiments of the present disclosure;

FIG. 5C illustrates a schematic diagram illustrating an example process of a measurement reporting based on a leaving cell list and a set of interested cells according to some embodiments of the present disclosure;

FIG. 5D illustrates a schematic diagram illustrating an example process of a measurement reporting based on a leaving cell list and weights of cells according to some embodiments of the present disclosure;

FIG. 6 illustrates a schematic diagram illustrating another process of communication for a measurement reporting according to some embodiments of the present disclosure;

FIG. 7 illustrates a schematic diagram illustrating an example process of a measurement reporting based on a beam measurement according to some embodiments of the present disclosure;

FIG. 8 illustrates a schematic diagram illustrating another process of communication for a measurement reporting according to some embodiments of the present disclosure;

FIG. 9 illustrates an example method of communication implemented at a terminal device in accordance with some embodiments of the present disclosure;

FIG. 10 illustrates another example method of communication implemented at a terminal device in accordance with some embodiments of the present disclosure;

FIG. 11 illustrates another example method of communication implemented at a terminal device in accordance with some embodiments of the present disclosure;

FIG. 12 illustrates another example method of communication implemented at a terminal device in accordance with some embodiments of the present disclosure; and

FIG. 13 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (cNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHZ), FR2 (24.25 GHz to 71 GHZ), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

As mentioned above, due to line of sight transmission and strong neighbor interference, aerial UE may see more cells with similar signal strength and more far away cells than a terrestrial UE. As a result, a measurement reporting may be frequently triggered, and interference caused by signaling may be increased.

In view of this, embodiments of the present disclosure provide solutions of communication for a measurement reporting so as to solve the above and other potential issues. In one aspect, if measurements for a first cell satisfy a first condition, a terminal device causes the first cell to be comprised in a first list. If the first list satisfies a second condition associated with a set of interested cells, the terminal device transmits a measurement report. In this way, a late measurement reporting may be avoided.

In another aspect, if measurements for a first cell satisfy a first condition, a terminal device causes the first cell to be comprised in a first list. If measurements for a second cell in the first list satisfy a third condition, the terminal device causes the second cell to be comprised in a second list. If the second list satisfies a fourth condition, the terminal device transmits a measurement report. In this way, a frequent measurement reporting due to fulfilling of leaving condition of a measurement event may be avoided.

In still another aspect, if measurements for a beam of a third cell satisfy a fifth condition, a terminal device causes the beam to be comprised in a third list. If the third list satisfies a sixth condition, the terminal device transmits a measurement report. In this way, a frequent measurement reporting due to seeing more cells at high altitude may be avoided.

In yet another aspect, a terminal device determines an eighth condition based on at least one of beam measurements or a height of the terminal device. If measurements for a fourth cell satisfy the eighth condition, the terminal device causes the fourth cell to be comprised in a fifth list for triggering a measurement report. In this way, an entering condition may be adapted and a frequent measurement reporting due to seeing more cells at high altitude may be avoided.

Principle and example embodiments of the present disclosure will be described in detail below with reference to the accompanying drawings.

### Example of Communication Network

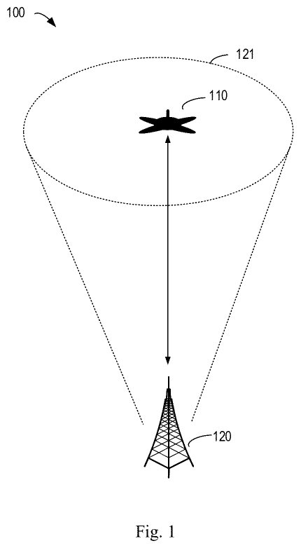

FIG. 1 shows an example communication environment 100 in which example embodiments of the present disclosure can be implemented. The network environment 100 includes a terminal device 110 and a network device 120 serving the terminal device 110. The network device 120 may provide one or more cells to the terminal device 110 or any other terminal devices not shown. In the example of FIG. 1, the network device 120 provides a serving cell 121 at an altitude above the network device 120.

For convenience, the following description will be given by assuming that the terminal device 110 is within the serving cell 121 of the network device 120. In the example of FIG. 1, the terminal device 110 is shown as an aerial terminal device. It is to be understood that embodiments of the present disclosure also apply to terrestrial terminal device.

In case that the terminal device 110 is within the serving cell 121 of the network device 120, the terminal device 110 may communicate with the network device 120 via such as a service link or radio link. Communication in a direction from a terminal device 110 towards the network device 120 is referred to as UL communication, while communication in a reverse direction from the network device 120 towards the terminal device 110 is referred to as DL communication.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of network device, terminal device and serving cell are only for the purpose of illustration without suggesting any limitations. The communication environment 100 may include any suitable access network device, terminal device and serving cell adapted for implementing embodiments of the present disclosure.

In some scenarios, the terminal device 110 may receive a measurement configuration from the network device 120 and perform radio measurements based on the measurement configuration. Then the terminal device 110 may report results of the radio measurements to the network device 120.

In some embodiments, the terminal device 110 may derive cell measurement results by measuring one or multiple beams associated per cell as configured by the network. For all cell measurement results, the terminal device 110 may apply the layer 3 filtering before using the measured results for evaluation of reporting criteria. For cell measurements, the network device 120 may configure reference signal received power (RSRP), reference signal received quality (RSRQ), signal to interference plus noise ratio (SINR), receive signal channel power (RSCP) or ratio of energy per modulating bit to the noise spectral density Ec/No (EcNO) as trigger quantity. For cell and beam measurements, reporting quantities may be any combination of quantities (i.e. only RSRP; only RSRQ; only SINR; RSRP and RSRQ; RSRP and SINR; RSRQ and SINR; RSRP, RSRQ and SINR; only RSCP; only EcNO; RSCP and EcNO). In some embodiments, Layer 3 beam filtered measurement may be derived based on synchronization signal and physical broadcast channel (SS/PBCH) block or channel state information reference signal (CSI-RS).

In some embodiments, if one or more cells trigger a measurement event, the terminal device 110 may initiate measurement reporting procedure. In some embodiments, the measurement events may comprise at least one of the following: Event A3 (Neighbour becomes offset better than SpCell), Event A4 (Neighbour becomes better than threshold), Event A5 (SpCell becomes worse than threshold1 and neighbour becomes better than threshold2), A6 (Neighbour becomes offset better than SCell), B1 (Inter RAT neighbour becomes better than threshold), or B2 (PCell becomes worse than threshold1 and inter RAT neighbour becomes better than threshold2). It is to be noted that the present application does not limited to above measurement events and corresponding entering conditions and leaving conditions, and any suitable measurement events and corresponding entering conditions and leaving conditions existing or to be future developed are feasible.

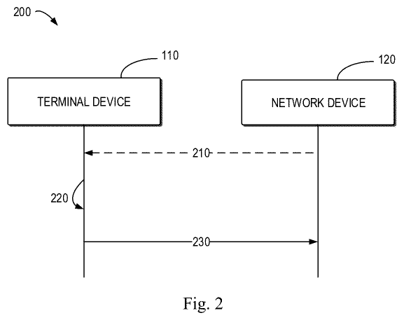

Embodiments of the present disclosure provide solutions of communication for a measurement reporting. This solution will be described in detail with reference to FIGS. 2 to 8.

### Example Implementation of Reporting Based on a Set of Interested Cells

FIG. 2 illustrates a schematic diagram illustrating a process 200 of communication for a measurement reporting according to embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the network device 120 may transmit 210 a measurement configuration to the terminal device 110. In some embodiments, the measurement configuration may indicate an entering condition for a measurement event (for convenience, also referred to as a first condition herein) and a triggering condition (for convenience, also referred to as a second condition herein) for a measurement report, the triggering condition being associated with an entering condition. The triggering condition is associated with a set of interested cells. In some embodiments, the measurement configuration may comprise the set of interested cells. It is to be understood that the measurement configuration may also comprise any other suitable information.

Based on the measurement configuration, the terminal device 110 may perform radio measurements.

With reference to FIG. 2, if measurements for a cell (for convenience, also referred to as a first cell herein) satisfy the entering condition, the terminal device 110 may cause 220 the first cell to be comprised in a list (for convenience, also referred to as a first list herein).

Continue to refer to FIG. 2, the terminal device may determine 220 whether the first list satisfies the triggering condition associated with the set of interested cells. If the first list satisfies the triggering condition, the terminal device 110 may transmit 230 a measurement report. For illustration, some example embodiments will be described in connection with Embodiments 1 to 3.

### Embodiment 1

In this embodiment, the set of interested cells may be a configured set of cells.

In some embodiments, if the number of cells in the first list is smaller than a predetermined number (for convenience, also referred to as a first predetermined number herein) and the first cell is indicated in the set of interested cells, the terminal device 110 may determine that the triggering condition is satisfied. In some embodiments, if the number of cells in the first list other than the first cell is greater than or equal to the first predetermined number and the first cell is indicated in the set of interested cells, the terminal device 110 may determine that the triggering condition is satisfied.

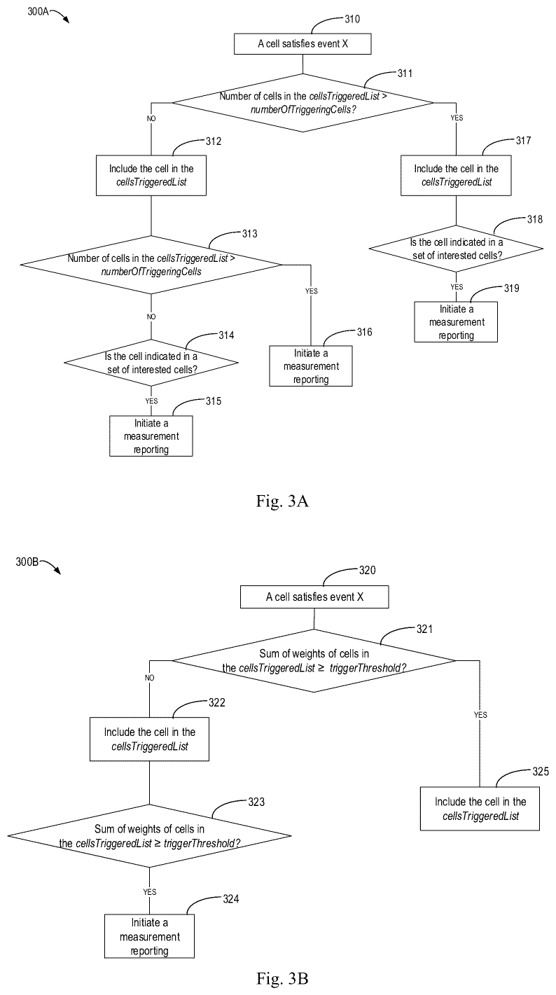

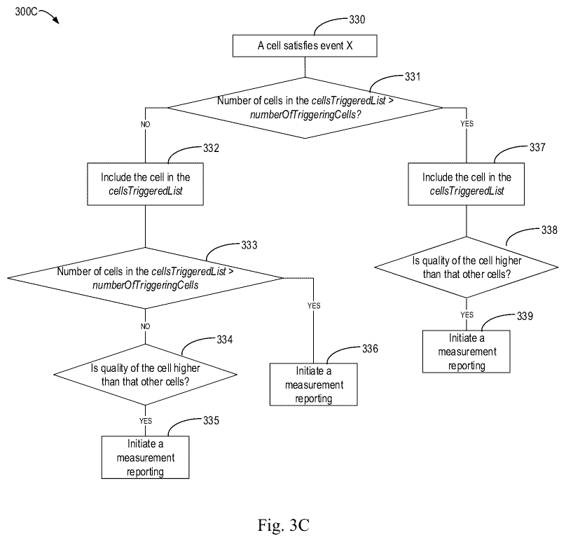

FIG. 3A illustrates a schematic diagram illustrating an example process 300A of a measurement reporting based on a set of interested cells according to some embodiments of the present disclosure. As shown in FIG. 3A, at step 310, the terminal device 110 may determine that a cell satisfies an entering condition for event X.

At step 311, the terminal device 110 may determine whether the number of cells in a list (e.g., cellTriggeredList) without the cell added is greater than or equal to a predetermine number (e.g., numberOfTriggeringCells). If the number of cells in the list without the cell added is smaller than the predetermine number, the process 300A may proceed to step 312.

At step 312, the terminal device 110 may add the cell into the list. At step 313, the terminal device 110 may determine whether the number of cells in the list with the cell added is greater than or equal to the predetermine number. If the number of cells in the list with the cell added is smaller than the predetermine number, the process 300A may proceed to step 314. At step 314, the terminal device 110 may determine whether the first cell is indicated in the set of interested cells. If the first cell is indicated in the set of interested cells, the process 300A may proceed to step 315. At step 315, the terminal device 110 may initiate a measurement report.

Return to step 313, if the number of cells in the list with the cell added is greater than or equal to the predetermine number, the process 300A may proceed to step 316. At step 316, the terminal device 110 may initiate a measurement report.

Return to step 311, if the number of cells in the list without the cell added is greater than or equal to the predetermine number, the process 300A may proceed to step 317. At step 317, the terminal device 110 may add the cell into the list. At step 318, the terminal device 110 may determine whether the first cell is indicated in the set of interested cells. If the first cell is indicated in the set of interested cells, the process 300A may proceed to step 319. At step 319, the terminal device 110 may initiate a measurement report.

It is to be understood that FIG. 3A is merely for illustration and is not intended for limitation. For example, one of steps 314 and 318 in FIG. 3A may be omitted. In some alternative embodiments, upon determination that the first cell satisfies an entering condition, the terminal device 110 may determine whether the first cell is indicated in the set of interested cells. If the first cell is indicated in the set of interested cells, the terminal device 110 may determine that the triggering condition is satisfied. Then a measurement report is transmitted.

In some embodiments, the terminal device 110 may cause fight path information to be comprised in the measurement report. In some embodiments, the fight path information may be used to determine the configured set of cells (i.e., the set of interested cells) by the network device 120. In this way, fight path information may be provided to the network device 120 for handover decisions.

### Embodiment 2

In this embodiment, the set of interested cells may be indicated by weights of cells.

In some embodiments, the terminal device 110 may determine weights of cells in the first list, e.g., from a configured set of weights for cells. In some embodiments, for a cell that is not configured with a weight, the terminal device 110 may consider that the weight of the cell is a default value. For example, the default value may be 1 unit. It is to be understood that any other suitable values are also feasible.

If a sum (denoted as triggerValue herein) of the weights of the cells in the first list is greater than or equal to a predetermined value (for convenience, also referred to as a first predetermined value herein), the terminal device 110 may determine that the triggering condition is satisfied and transmit a measurement report (denoted as MR herein). In some embodiments, upon transmitting a measurement report, the terminal device 110 may reset the sum of the weights, e.g., to zero or any other suitable values. In this way, a measurement report may be initiated every time the sum of the weights of the cells in the first list is greater than or equal to a predetermined value.

For illustration, an example procedure may be described as below.

```
2> if the triggerType is set to event and if the entry condition applicable for this event, i.e.
the event corresponding with the eventId of the corresponding reportConfig within
VarMeasConfig, is fulfilled for one or more applicable cells for all measurements after layer
3 filtering taken during timeToTrigger defined for this event within the VarMeasConfig:
  3> If the VarMeasReportList does not include a measurement reporting entry for this
measId:
    4> include a measurement reporting entry within the VarMeasReportList for this
measId;
  3> include the concerned cell(s) in the cellsTriggeredList defined within the
VarMeasReportList for this measId;
  3> If the triggerWeight is configured for the concerned cell
    4> increment the triggerValue by the value of triggerWeight;
  3> else
    4> increment the triggerValue by default value (i.e., 1);
  3> If the triggerValue is larger than or equal to triggerThreshold:
    4> initiate the measurement reporting procedure;
    (4> set the triggerValue for this measId to 0) - Optional.
```

In some embodiments, if a sum of weights of cells in the first list other than the first cell is smaller than the first predetermined value, the terminal device 110 may add the first cell in the first list and determine whether a sum of weights of cells in the first list with the first cell added is greater than or equal to the first predetermined value. If the a sum of weights of cells in the first list with the first cell added is greater than or equal to the first predetermined value, the terminal device 110 may determine that the triggering condition is satisfied. Then the measurement reporting may be triggered. In this way, once the measurement report is triggered, the terminal device 110 will not trigger the measurement report continuously unless the predetermined value for the sum of the weights is fulfilled again after the sum of the weights being less than the predetermined value.

In some embodiments, if a cell in the first list satisfied a leaving condition for the measurement event, a weight of the cell will be subtracted from the sum of the weights of cells in the first list.

For illustration, an example procedure may be described as below.

```
2> if the triggerType is set to event and if the entry condition applicable for this event, i.e.
the event corresponding with the eventId of the corresponding reportConfig within
VarMeasConfig, is fulfilled for one or more applicable cells for all measurements after layer
3 filtering taken during timeToTrigger defined for this event within the VarMeasConfig:
  3> If the VarMeasReportList does not include a measurement reporting entry for this
measId:
    4> include a measurement reporting entry within the VarMeasReportList for this
measId;
  3> include the concerned cell(s) in the cellsTriggeredList defined within the
VarMeasReportList for this measId;
  3> If the triggerValue (the sum of the triggerWeight of all cells in cellsTriggeredList) is
larger than or equal to triggerThreshold
    4> If the triggerWeight is configured for the concerned cell
      5> increment the triggerValue by the value of triggerWeight;
    4> else
      5> increment the triggerValue by default value (i.e., 1);
  3> else:
    4> If the triggerWeight is configured for the concerned cell:
      5> increment the triggerValue by the value of triggerWeight;
    4> else
      5> increment the triggerValue by default value (i.e., 1);
    4> If the triggerValue is larger than or equal to triggerThreshold:
      5> set the numberOfReportsSent defined within the VarMeasReportList for
this measId to 0;
      5> initiate the measurement reporting procedure.
```

FIG. 3B illustrates a schematic diagram illustrating an example process 300B of a measurement reporting based on a weight of a cell according to some embodiments of the present disclosure. As shown in FIG. 3B, at step 320, the terminal device 110 may determine that a cell satisfies an entering condition for event X.

At step 321, the terminal device 110 may determine whether a sum of weights of cells in a list (e.g., cellTriggeredList) without the cell added is greater than or equal to a predetermine value (e.g., triggerThreshold). If the sum of weights of cells in the list without the cell added is smaller than the predetermine value, the process 300B may proceed to step 322.

At step 322, the terminal device 110 may add the cell into the list. At step 323, the terminal device 110 may determine whether the sum of weights of cells in the list with the cell added is greater than or equal to the predetermine value. If the sum of weights of cells in the list with the cell added is greater than or equal to the predetermine value, the process 300B may proceed to step 324. At step 324, the terminal device 110 may initiate a measurement report.

Return to step 321, if the number of cells in the list without the cell added is greater than or equal to the predetermine number, the process 300B may proceed to step 325. At step 325, the terminal device 110 may add the cell into the list (e.g., cellTriggeredList).

It is to be understood that FIG. 3B is merely for illustration and is not intended for limitation.

Table 1 below shows an example comparison among the above measurement reporting solutions based on weights of cells. In this example, triggerThreshold=6.

TABLE 1

| | | cellTriggeredList | | | | |
|---|---|---|---|---|---|---|
| Time | Events | cell(weight) | triggerValue | MR(Op1) | MR(Op2) | MR(Op3) |
| T1 | Cell A | A(2) | 2 | | | |
| | enters | | | | | |
| T2 | Cell B | A(2), B(1) | 3 | | | |
| | enters | | | | | |
| T3 | Cell A | B(1) | 1 | | | |
| | leaves | | | | | |
| T4 | Cell B | | | | | |
| | leaves | | | | | |
| T5 | Cell D | D(3) | 3 | | | |
| | enters | | | | | |
| T6 | Cell E | D(3), E(2) | 5 | | | |
| | enters | | | | | |
| T7 | Cell F | D(3), E(2), F(1) | 6 | MR | MR | MR(reset |
| | enters | | | | | triggerValue |
| | | | | | | to 0) |
| T8 | Cell C | D(3), E(2), F(1), | 8 | | MR | (2) |
| | enters | C(2) | | | | |
| T9 | Cell C | D(3), E(2), F(1) | 6 | | MR | (0) |
| | leaves | | | | | |
| T10 | Cell D | E(2), F(1) | 3 | | | (0) |
| | leaves | | | | | |
| T11 | Cell G | E(2), F(1), G(3) | 6 | MR | MR | (3) |
| | enters | | | | | |

Op1: when a first cell satisfies entering condition, if a sum of weights of cells in the list without the first cell added is smaller than a predetermined value and a sum of weights of cells in the first list with the first cell added is greater than or equal to the predetermined value, a measurement report is initiated;
Op2: when a first cell satisfies entering condition, if a sum of weights of cells in the first list with the first cell added is greater than or equal to the predetermined value, a measurement report is initiated;
Op3: when a first cell satisfies entering condition, if a sum of weights of cells in the first list with the first cell added is greater than or equal to the predetermined value, a measurement report is initiated. Upon transmission of the measurement report, the sum of weights is reset to 0.

### Embodiment 3

In this embodiment, the set of interested cells may be indicated by quality of cells.

In some embodiments, if quality of the first cell is better than quality of other cells in the first list, the terminal device 110 may determine that the triggering condition is satisfied and transmit a measurement report.

In some embodiments, if the number of cells in the first list with the first cell added is smaller than a predetermined number and quality of the first cell is better than quality of other cells in the first list, the terminal device 110 may determine that the triggering condition is satisfied and transmit a measurement report.

In some embodiments, if the number of cells in the first list other than the first cell is greater than or equal to the predetermined number and quality of the first cell is higher than quality of other cells (e.g., the best cell) in the first list, the terminal device 110 may determine that the triggering condition is satisfied and transmit a measurement report. In some embodiments, if the number of cells in the first list other than the first cell is greater than or equal to the predetermined number and quality of the first cell is higher than quality of other cells (e.g., the best cell) in the first list by a predetermined level, the terminal device 110 may determine that the triggering condition is satisfied and transmit a measurement report.

For illustration, an example procedure may be described as below.

```
2> if the triggerType is set to event and if the corresponding reportConfig includes
numberOfTriggeringCells, and if the entry condition applicable for this event, i.e. the event
corresponding with the eventId of the corresponding reportConfig within VarMeasConfig, is
fulfilled for one or more applicable cells for all measurements after layer 3 filtering taken
during timeToTrigger defined for this event within the VarMeasConfig:
  3> If the VarMeasReportList does not include a measurement reporting entry for this
measId:
    4> include a measurement reporting entry within the VarMeasReportList for this
measId;
  3> If the number of cell(s) in the cellsTriggeredList is larger than or equal to
numberOfTriggeringCells:
    4> include the concerned cell(s) in the cellsTriggeredList defined within the
VarMeasReportList for this measId;
    4> if the the measurement results of the concerned cell is better than the best cell
included in the cellsTriggeredList
      5> initiate the measurement reporting procedure;
  3> else:
    4> include the concerned cell(s) in the cellsTriggeredList defined within the
VarMeasReportList for this measId;
    4> If the number of cell(s) in the cellsTriggeredList is larger than or equal to
numberOfTriggeringCells:
      5> set the numberOfReportsSent defined within the VarMeasReportList for
this measId to 0;
      5> initiate the measurement reporting procedure.
```

FIG. 3C illustrates a schematic diagram illustrating an example process 300C of a measurement reporting based on quality of a cell according to some embodiments of the present disclosure. As shown in FIG. 3C, at step 330, the terminal device 110 may determine that a cell satisfies an entering condition for event X.

At step 331, the terminal device 110 may determine whether the number of cells in a list (e.g., cellTriggeredList) without the cell added is greater than or equal to a predetermine number (e.g., numberOfTriggeringCells). If the number of cells in the list without the cell added is smaller than the predetermine number, the process 300C may proceed to step 332.

At step 332, the terminal device 110 may add the cell into the list. At step 333, the terminal device 110 may determine whether the number of cells in the list with the cell added is greater than or equal to the predetermine number. If the number of cells in the list with the cell added is smaller than the predetermine number, the process 300C may proceed to step 334. At step 334, the terminal device 110 may determine whether quality of the first cell is higher than quality of other cells (e.g., the best cell) in the first list. If quality of the first cell is higher than quality of other cells (e.g., the best cell), the process 300C may proceed to step 335. At step 335, the terminal device 110 may initiate a measurement report.

Return to step 333, if the number of cells in the list with the cell added is greater than or equal to the predetermine number, the process 300C may proceed to step 336. At step 336, the terminal device 110 may initiate a measurement report.

Return to step 331, if the number of cells in the list without the cell added is greater than or equal to the predetermine number, the process 300C may proceed to step 337. At step 337, the terminal device 110 may add the cell into the list. At step 338, the terminal device 110 may determine whether the quality of the first cell is higher than quality of other cells (e.g., the best cell). If the quality of the first cell is higher than quality of other cells (e.g., the best cell), the process 300C may proceed to step 339. At step 339, the terminal device 110 may initiate a measurement report.

It is to be understood that FIG. 3C is merely for illustration and is not intended for limitation. For example, one of steps 334 and 338 in FIG. 3C may be omitted.

### Example Implementation of Reporting Based on a Leaving Cell List

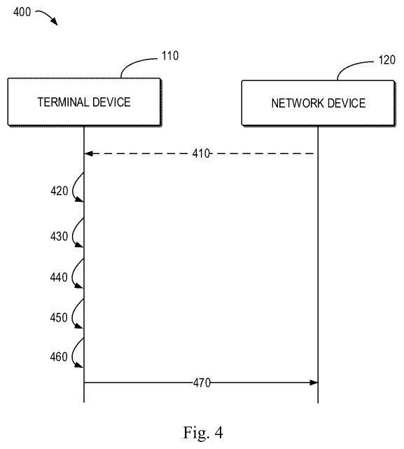

FIG. 4 illustrates a schematic diagram illustrating another process 400 of communication for a measurement reporting according to embodiments of the present disclosure. For the purpose of discussion, the process 400 will be described with reference to FIG. 1. The process 400 may involve the terminal device 110 and the network device 120 as illustrated in FIG. 1.

As shown in FIG. 4, the network device 120 may transmit 410 a measurement configuration to the terminal device 110. In some embodiments, the measurement configuration may indicate an entering condition (for convenience, also referred to as a first condition herein), a leaving condition (for convenience, also referred to as a third condition herein) and a triggering condition (for convenience, also referred to as a fourth condition herein) for a measurement report, the triggering condition being associated with an leaving condition. It is to be understood that the measurement configuration may also comprise any other suitable information.

Based on the measurement configuration, the terminal device 110 may perform radio measurements. With reference to FIG. 4, the terminal device 110 determines 420 whether measurements for a cell (for convenience, also referred to as a first cell herein) satisfy the entering condition. If measurements for the first cell satisfy the entering condition, the terminal device 110 may cause 430 the first cell to be comprised in a list (for convenience, also referred to as a first list herein). It is to be noted that the present application does not limit the entering condition, and any suitable conditions are feasible.

Continue to refer to FIG. 4, the terminal device 110 determines 440 whether measurements for a cell (for convenience, also referred to as a second cell herein) in the first list satisfy the leaving condition. If the measurements for the second cell satisfy the leaving condition, the terminal device 110 may cause 450 the second cell to be comprised in a list (for convenience, also referred to as a second list or a leaving cell list herein). In some embodiments, if the second cell has been reported in a previous measurement report (e.g., the latest measurement report), the terminal device 110 may determine that the leaving condition is satisfied and may add the second cell into the second list.

With reference to FIG. 4, the terminal device 110 determines 460 whether the second list satisfies the triggering condition. If the second list satisfies the triggering condition, the terminal device 110 may transmit 470 a measurement report. In some embodiments, if the second list satisfies the triggering condition, the terminal device 110 may also cause the second list to be empty, e.g., remove all the items in the second list.

In some embodiments, if a cell in the second list re-satisfies an entering condition, the cell may be removed from the second list and added in the first list.

For illustration, some example embodiments will be described in connection with Embodiments 4 to 8.

### Embodiment 4

In this embodiment, the triggering condition is associated with a leaving cell list.

In some embodiments, if the number of cells in the second list is greater than or equal to a predetermined number (for convenience, also referred to as a second predetermined number herein), the terminal device 110 may determine that the triggering condition is satisfied and may transmit the measurement report.

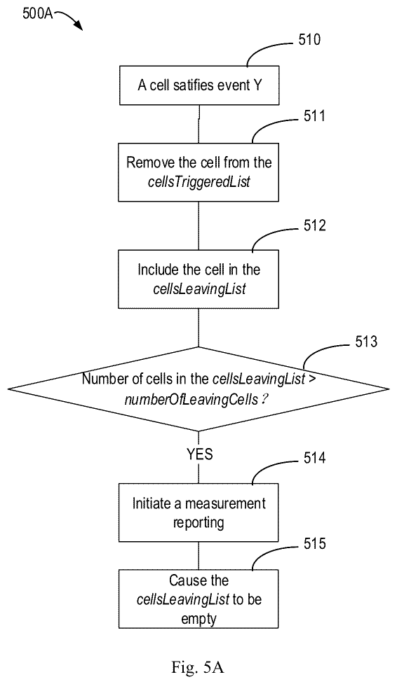

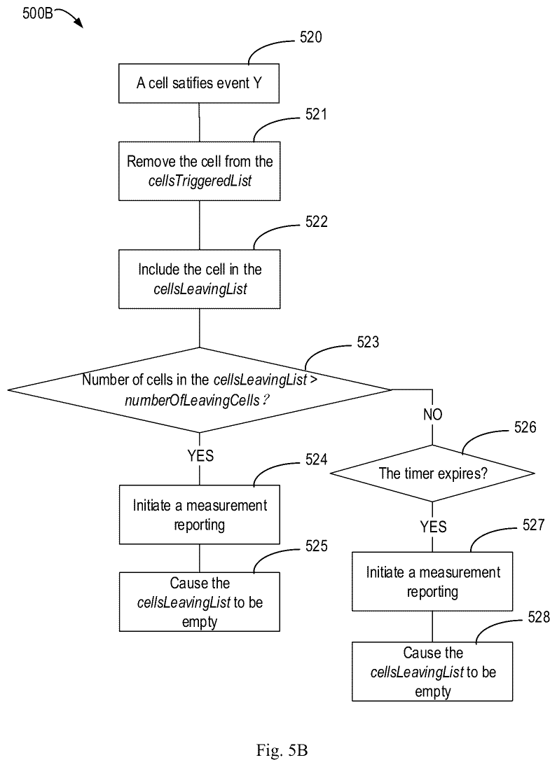

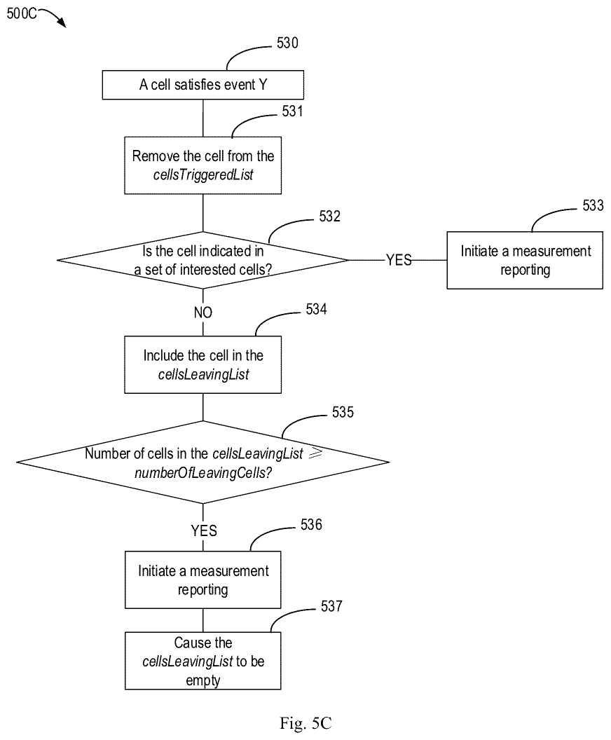

FIG. 5A illustrates a schematic diagram illustrating an example process 500A of a measurement reporting based on a leaving cell list according to some embodiments of the present disclosure. As shown in FIG. 5A, at step 510, the terminal device 110 may determine that a cell satisfies a leaving condition for event Y.

At step 511, the terminal device 110 may remove the second cell from the first list. At step 512, the terminal device 110 may cause the second cell to be comprised in the second list. At step 513, the terminal device 110 may determine whether the number of cells in the second list (e.g., cellsLeavingList) with the second cell added is greater than or equal to a predetermine number (e.g., numberOfLeavingCells). If the number of cells in the second list with the cell added is greater than or equal to the predetermine number, the process 500A may proceed to step 514. At step 514, the terminal device 110 may initiate a measurement report. At step 515, the terminal device 110 may cause the second list to be empty.

It is to be understood that FIG. 5A is merely for illustration and is not intended for limitation. In some alternative embodiments, if the number of cells in the second list is greater than or equal to the second predetermined number and at least one cell in the second list has been reported in a previous measurement report (e.g., the latest measurement report), the terminal device 110 may determine that the triggering condition is satisfied and may transmit the measurement report.

Table 2 below shows an example comparison between a legacy solution without a leaving cell list and the present solution based on a leaving cell list. In this example, numberOfLeavingCells=2.

TABLE 2

| Time | Events | cellTriggeredList | cellLeavingList | Legacy | MR(Op1) | MR(Op2) |
|---|---|---|---|---|---|---|
| T1 | Cell A | A | | | | |
| | enters | | | | | |
| T2 | Cell B | A, B | | | | |
| | enters | | | | | |
| T3 | Cell A | B | A | MR | | |
| | leaves | | | | | |
| T4 | Cell B | | A, B | MR | MR | |
| | leaves | | | | | |
| T5 | Cell D | D | | | | |
| | enters | | | | | |
| T6 | Cell E | D, E | | | | |
| | enters | | | | | |
| T7 | Cell F | D, E, F | | MR | MR | MR |
| | enters | | | | | |
| T8 | Cell C | D, E, F, C | | | | |
| | enters | | | | | |
| T9 | Cell C | D, E, F | C | MR | | |
| | leaves | | | | | |
| T10 | Cell D | E, F | C, D | MR | MR | MR |
| | leaves | | | | | |

Op1: if the number of cells in the leaving cell list is greater than or equal to a predetermined value, a measurement report is initiated;
Op2: if the number of cells in the leaving cell list is greater than or equal to a predetermined value and at least one of the cells in the leaving cell list has been triggered or reported in a previous measurement report, a measurement report is initiated.

### Embodiment 5

In this embodiment, the triggering condition is associated with at least one of a leaving cell list or a timer (also referred to as a report delay timer herein).

In some embodiments, if the second list is empty, the terminal device 110 may start a timer upon addition of the second cell in the second list. In some embodiments, if the timer expires, the terminal device 110 may determine that the triggering condition is satisfied and may transmit a measurement report.

FIG. 5B illustrates a schematic diagram illustrating another example process 500B of a measurement reporting based on a leaving cell list according to some embodiments of the present disclosure. As shown in FIG. 5B, at step 520, the terminal device 110 may determine that a cell satisfies a leaving condition for event Y.

At step 521, the terminal device 110 may remove the second cell from the first list. At step 522, the terminal device 110 may cause the second cell to be comprised in the second list. If the second list is empty, the terminal device 110 may start a timer. Upon transmission of a measurement report, the terminal device 110 may stop the timer if the timer is running.

At step 523, the terminal device 110 may determine whether the number of cells in the second list (e.g., cellsLeavingList) with the second cell added is greater than or equal to a predetermine number (e.g., numberOfLeavingCells). If the number of cells in the second list with the cell added is greater than or equal to the predetermine number, the process 500A may proceed to step 524. At step 524, the terminal device 110 may initiate a measurement report. At step 525, the terminal device 110 may cause the second list to be empty. The present disclosure does not limit the order of the steps 524 and 525.

Return to step 523, if the number of cells in the second list with the second cell added is smaller than the predetermine number, the process 500B may proceed to step 526. At step 526, the terminal device 110 may determine whether the timer expires. If the timer expires, the process 500B may proceed to step 527. At step 527, the terminal device 110 may initiate a measurement report. At step 528, the terminal device 110 may cause the second list to be empty. The present disclosure does not limit the order of the steps 527 and 528.

It is to be understood that FIG. 5B is merely for illustration and is not intended for limitation. In some alternative embodiments, if the number of cells in the second list with the second cell added is greater than or equal to the second predetermined number and the timer is running, the terminal device 110 may determine that the triggering condition is satisfied and may transmit a measurement report.

For illustration, an example behavior of the timer may be described as below.
The start of the report delay timer: Upon including the first concerned cells in the cellsLeavingList
if the cellsleavingList defined within the VarMeasReportList for this measId is empty,
include the concerned cell(s) in the cellsTriggeredList defined within the VarMeasReportList for this measId;
Start or restart the report delay timer;
   The stop of the report delay timer:
Upon initiate the measurement reporting procedure for this event, stop the report delay timer, if running;
   The expiry of the report delay timer:

### Option 1:

Upon expiry of the report delay timer, initiate measurement reporting procedure for this event

### Option 2:

If the number of cell(s) in the cellsLeavingList is larger than or equal to numberOfTriggeringCells, or the report delay timer, if configured, is not running:
initiate the measurement reporting procedure.

### Embodiment 6

In this embodiment, the triggering condition is associated with a leaving cell list and a set of interested cells.

In some embodiments, if the second cell is indicated in the set of interested cells, the terminal device 110 may determine that the triggering condition is satisfied.

In some embodiments, if the number of cells in the second list is smaller than the second predetermined number and the second cell is indicated in the set of interested cells, the terminal device 110 may determine that the triggering condition is satisfied.

In some embodiments, if the number of cells in the second list other than the second cell is greater than or equal to the second predetermined number and the second cell is indicated in the set of interested cells, the terminal device 110 may determine that the triggering condition is satisfied.

FIG. 5C illustrates a schematic diagram illustrating an example process 500C of a measurement reporting based on a leaving cell list and a set of interested cells according to some embodiments of the present disclosure. As shown in FIG. 5C, at step 530, the terminal device 110 may determine that a cell satisfies a leaving condition for event Y.

At step 531, the terminal device 110 may remove the second cell from the first list.

At step 532, the terminal device 110 may determine whether the second cell is indicated in the set of interested cells. If the second cell is indicated in the set of interested cells, the process 500C may proceed to step 533. At step 533, the terminal device 110 may determine that the triggering condition is satisfied and initiate a measurement report.

Return to step 532, if the second cell is not indicated in the set of interested cells, the process 500C may proceed to step 534. At step 534, the terminal device 110 may add the second cell into the second list. At step 535, the terminal device 110 may determine whether the number of cells in the second list (e.g., cellsLeavingList) with the second cell added is greater than or equal to a predetermine number (e.g., numberOfLeavingCells). If the number of cells in the second list with the second cell added is greater than or equal to the predetermine number, the process 500C may proceed to step 536. At step 536, the terminal device 110 may determine that the triggering condition is satisfied and initiate a measurement report. At step 537, the terminal device 110 may cause the second list to be empty.

It is to be understood that FIG. 5C is merely for illustration and is not intended for limitation.

### Embodiment 7

In this embodiment, the triggering condition is associated with a leaving cell list and weights of cells.

In some embodiments, the terminal device 110 may determine weights of cells in the second list. If a sum of the weights of the cells in the second list with or without the second cell added is greater than or equal to a predetermined value (for convenience, also referred to as a second predetermined value herein), the terminal device 110 may determine that the triggering condition is satisfied and transmit a measurement report.

In some embodiments, if a sum of weights of cells in the second list other than the second cell is smaller than the second predetermined value and a sum of the weights of the cells in the second list with the second cell added is greater than or equal to the second predetermined value, the terminal device 110 may determine that the triggering condition is satisfied and transmit a measurement report.

In some embodiments, upon transmission of the measurement report, the terminal device 110 may reset the sum of the weights.

FIG. 5D illustrates a schematic diagram illustrating an example process 500D of a measurement reporting based on a leaving cell list and weights of cells according to some embodiments of the present disclosure. As shown in FIG. 5D, at step 540, the terminal device 110 may determine that a cell satisfies a leaving condition for event Y.

At step 541, the terminal device 110 may remove the second cell from the first list. At step 542, the terminal device 110 may add the second cell into the second list. At step 543, the terminal device 110 may determine whether the sum of weights of cells in the list with the second cell added is greater than or equal to the predetermine value. If the sum of weights of cells in the list with the second cell added is greater than or equal to the predetermine value, the process 500D may proceed to step 544. At step 544, the terminal device 110 may initiate a measurement report and cause the second list to be empty.

It is to be understood that FIG. 5D is merely for illustration and is not intended for limitation.

For illustration, an example procedure may be described as below.

```
2> else if the reportType is set to eventTriggered and if the leaving condition applicable for
this event is fulfilled for one or more of the cells included in the cellsTriggeredList defined
within the VarMeasReportList for this measId for all measurements after layer 3 filtering
taken during timeToTrigger defined within the VarMeasConfig for this event:
  3> remove the concerned cell(s) in the cellsTriggeredList defined within the
VarMeasReportList for this measId;
  3> if reportOnLeave is set to true and triggerThreshold is not configured for the
corresponding reporting configuration:
    4> initiate the measurement reporting procedure, as specified in 5.5.5;
  3> if reportOnLeave is set to true and triggerThreshold is configured for the
corresponding reporting configuration:
    4> include the concerned cell(s) in the cellsLeavingList for this measId;
    4> If the triggerValue (the sum of the triggerWeight of all cells in cellsLeavingList)
is larger than or equal to triggerThreshold
      5> initiate the measurement reporting procedure;
      5> set the triggerValue for this measId to 0 (or remove cells in
cellsLeavingList).
```

### Embodiment 8

In this embodiment, the triggering condition is associated with a leaving of a cell and quality of the cell.

In some embodiments, when the second cell satisfies an leaving condition, if quality of the second cell is worse than quality of other cells (e.g., the worst cell) in the second list, the terminal device 110 may determine that the triggering condition is satisfied.

In some embodiments, if the number of cells in the second list with the second cell added is smaller than the predetermine number, and quality of the second cell is worse than quality of other cells (e.g., the worst cell) in the second list, the terminal device 110 may determine that the triggering condition is satisfied.

### Example Implementation of Reporting Based on Beam Measurements

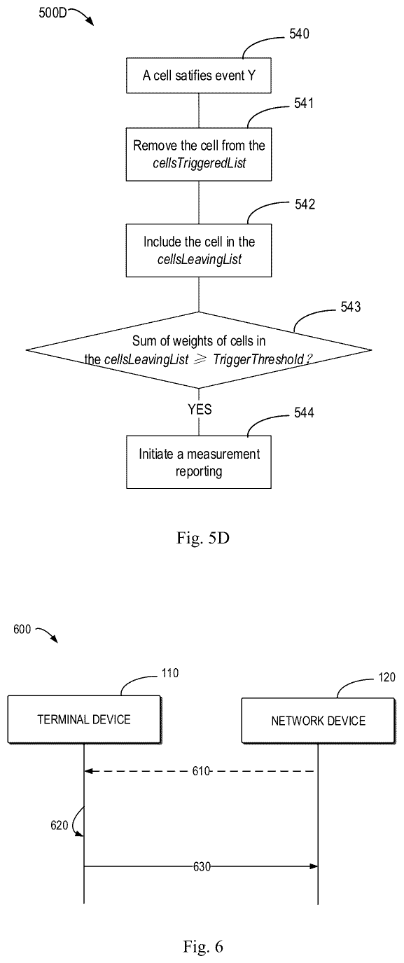

FIG. 6 illustrates a schematic diagram illustrating another process 600 of communication for a measurement reporting according to embodiments of the present disclosure. For the purpose of discussion, the process 600 will be described with reference to FIG. 1. The process 600 may involve the terminal device 110 and the network device 120 as illustrated in FIG. 1.

As shown in FIG. 6, the network device 120 may transmit 610 a measurement configuration to the terminal device 110. In some embodiments, the measurement configuration may indicate an entering condition associated with beam measurements (for convenience, also referred to as a fifth condition herein), and a corresponding triggering condition (for convenience, also referred to as a sixth condition herein) for a measurement report. In some embodiments, the measurement configuration may also indicate an entering condition associated with cell measurements (for convenience, also referred to as a seventh condition herein). It is to be understood that the measurement configuration may also comprise any other suitable information.

Based on the measurement configuration, the terminal device 110 may perform beam measurements. With reference to FIG. 6, if measurements for a beam of a cell (for convenience, also referred to as a third cell herein) satisfy the fifth condition, the terminal device 110 may cause 620 the beam to be comprised in a list (for convenience, also referred to as a third list herein). It is to be noted that the present application does not limit the fifth condition, and any suitable conditions are feasible.

Continue to refer to FIG. 6, if the third list satisfy the sixth condition (i.e., the triggering condition), the terminal device 110 may transmit 630 a measurement report. For illustration, some example embodiments will be described in connection with Embodiments 9 to 11.

### Embodiment 9

In this embodiment, the triggering condition is associated with the number of beams in a cell.

In some embodiments, if the number of beams of the third cell in the third list is greater than or equal to a predetermined number (for convenience, also referred to as a third predetermined number herein), the terminal device 110 may determine that the third list satisfies the triggering condition.

For example, an example procedure of a beam-based measurement event may be described as below.

The UE shall:
1> consider the entering condition for this event to be satisfied when
condition A4-1′, as specified below, is fulfilled;
1> consider the leaving condition for this event to be satisfied when
condition A4-2′, as specified below, is fulfilled.
Inequality A4-1′ (Entering condition)
Mn + offset value − Hys > Thresh
Inequality A4-2′ (Leaving condition)
Mn + offset value + Hys < Thresh

The variables in the formula are defined as follows:
Mn is the beam measurement result derived based on SS/PBCH block or CSI-RS of the neighbouring cell (or, if reportType is set to eventBeamTriggered, Mn is the beam measurement result derived based on SS/PBCH block or CSI-RS of the neighbouring cell), not taking into account any offsets.
offset value is the sum of other offset values
Hys is the hysteresis parameter for this event (i.e. hysteresis as defined within reportConfigNR for this event).
Thresh is the threshold parameter for this event;

```
  2> if the reportType is set to eventTriggered (i.e., eventBeamTriggered) and if the
corresponding reportConfig includes numberOfTriggeringBeams, and if the entry condition
applicable for this event, i.e. the event corresponding with the eventId of the corresponding
reportConfig within VarMeasConfig, is fulfilled for one or more beams of applicable cell(s)
for all measurements after layer 3 filtering taken during timeToTrigger defined for this event
within the VarMeasConfig:
    3> If the VarMeasReportList does not include a measurement reporting entry for
this measId:
      4> include a measurement reporting entry within the VarMeasReportList for
this measId;
    3> If the concerned cell(s) is not included in the cellsTriggeredList
      4> include the concerned cell(s) in the cellsTriggeredList defined within the
VarMeasReportList for this measId;
    3> If the number of beam(s) in the beamsTriggeredList is larger than or equal to
numberOfTriggeringBeams:
      4> include the concerned beam(s) in the beamsTriggeredList for the
corresponding cell(s);
    3> else:
      4> include the concerned beam(s) in the beamsTriggeredList for the
corresponding cell(s);
        5> If the number of beam(s) in the beamsTriggeredList is larger than or
equal to numberOfTriggeringBeams:
          6> set the numberOfReportsSent defined within the
VarMeasReportList for this measId to 0;
          6> initiate the measurement reporting procedure.
```

### Embodiment 10

In this embodiment, the triggering condition is associated with the number of beams in the third list. The beams in the third list may belong to different cells.

In some embodiments, if the number of beams in the third list is greater than or equal to a predetermined number (for convenience, also referred to as a fourth predetermined number herein), the terminal device 110 may determine that the third list satisfies the triggering condition.

In some embodiments, if the measurement report is transmitted, the terminal device 110 may reset the number of beams in the third list.

For example, an example procedure may be described as below.

```
2> if the reportType is set to eventTriggered (i.e., eventBeamTriggered) and if the
corresponding reportConfig includes sumNumberOfTriggeringBeams, and if the entry
condition applicable for this event, i.e. the event corresponding with the eventId of the
corresponding reportConfig within VarMeasConfig, is fulfilled for one or more beams of
applicable cell(s) for all measurements after layer 3 filtering taken during timeToTrigger
defined for this event within the VarMeasConfig:
  3> If the VarMeasReportList does not include a measurement reporting entry for this
measId (a first cell triggers the event):
    4> include a measurement reporting entry within the VarMeasReportList for this
measId;
  3> If the concerned cell(s) is not included in the cellsTriggeredList
    4> include the concerned cell(s) in the cellsTriggeredList defined within the
VarMeasReportList for this measId;
  3> If numberOfBeams is larger than or equal to sumNumberOfTriggeringBeams
  3> Increment the triggeringBeamsCount by the number of beams fulfilled the entry
condition applicable for this event
  3> else
    4> Increment the triggeringBeamsCount by the number of beams fulfilled the entry
condition applicable for this event
  3> If numberOfBeams is larger than or equal to sumNumberOfTriggeringBeams
    4> initiate the measurement reporting procedure.
```

### Embodiment 11

In some embodiments, if measurements for the third cell satisfy the entering condition (i.e., the seventh condition), the terminal device 110 may cause the third cell to be comprised in a list (for convenience, also referred to as a fourth list herein). If the number of cells in the fourth list is smaller than a predetermined number (for convenience, also referred to as a fifth predetermined number herein) and the number of beams in the third list is greater than or equal to the fourth predetermined number, the terminal device 110 may determine that the third list satisfies the triggering condition, and may initiate a measurement report.

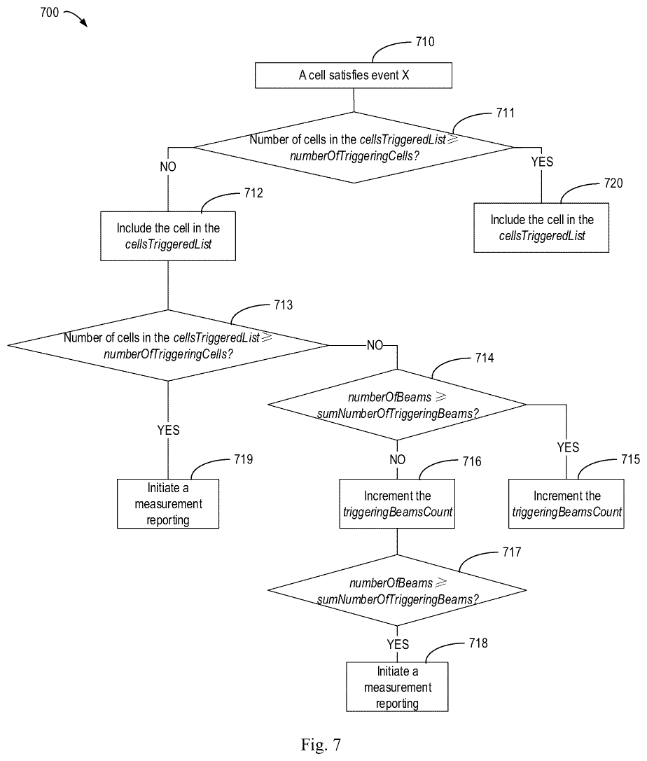

FIG. 7 illustrates a schematic diagram illustrating an example process 700 of a measurement reporting based on a beam measurement according to some embodiments of the present disclosure. As shown in FIG. 7, at step 710, the terminal device 110 may determine that a cell satisfies an entering condition for event X.

At step 711, the terminal device 110 may determine whether the number of cells in the fourth list without the third cell added is greater than or equal to a predetermine number (e.g., numberOfTriggeringCells). If the number of cells in the fourth list without the third cell added is smaller than the predetermine number, the process 700 may proceed to step 712. At step 712, the terminal device 110 may add the third cell into the fourth list.

At step 713, the terminal device 110 may determine whether the number of cells in the fourth list with the third cell added is greater than or equal to the predetermine number. If the number of cells in the fourth list with the third cell added is smaller than the predetermine number, the process 700 may proceed to step 714.

At step 714, the terminal device 110 may determine whether the number (e.g., triggeringBeamsCount) of beams in the third list is greater than or equal to a predetermined number (e.g., numberOfTriggeringBeams). If the number of beams in the third list is greater than or equal to the predetermined number, the process 700 may proceed to step 715. At step 715, the terminal device 110 may increment the number of beams in the third list. It is to be understood that the beams in the third list may belong to different cells.

Return to step 714, if the number of beams in the third list is smaller than the predetermined number, the process 700 may proceed to step 716. At step 716, the terminal device 110 may increment the number of beams in the third list. At step 717, the terminal device 110 may determine whether the number of beams in the third list is greater than or equal to the predetermined number. If the number of beams in the third list is greater than or equal to the predetermined number, at step 718, the terminal device 110 may initiate a measurement report.

Return to step 713, if the number of cells in the fourth list with the third cell added is greater than or equal to the predetermine number, the process 700 may proceed to step 719. At step 719, the terminal device 110 may initiate a measurement report.

Return to step 711, if the number of cells in the fourth list without the third cell added is greater than or equal to the predetermine number, the process 700 may proceed to step 720. At step 720, the terminal device 110 may add the third cell into the fourth list.

It is to be understood that FIG. 7 is merely for illustration and is not intended for limitation.

For illustration, an example procedure may be described as below.

```
2> if the reportType is set to eventTriggered (i.e., eventBeamTriggered) and if the
corresponding reportConfig includes numberOfTriggeringBeams, and if the entry condition
applicable for this event, i.e. the event corresponding with the eventId of the corresponding
reportConfig within VarMeasConfig, is fulfilled for one or more beams of applicable cell(s)
for all measurements after layer 3 filtering taken during timeToTrigger defined for this event
within the VarMeasConfig:
  3> If the VarMeasReportList does not include a measurement reporting entry for this
measId (a first cell triggers the event):
    4> include a measurement reporting entry within the VarMeasReportList for this
measId;
  3> If the number of cell(s) in the cellsTriggeredList is larger than or equal to
numberOfTriggeringCells:
    4> If the concerned cell(s) is not included in the cellsTriggeredList
      5> include the concerned cell(s) in the cellsTriggeredList defined within the
VarMeasReportList for this measId;
  3> else
    4> if the concerned cell(s) is not included in the cellsTriggeredList:
      5> include the concerned cell(s) in the cellsTriggeredList defined within the
VarMeasReportList for this measId;
    4> If the number of cell(s) in the cellsTriggeredList is larger than or equal to
numberOfTriggeringCells:
      5>
      5> initiate the measurement reporting procedure, as specified in 5.5.5
    4 > else:
      5 > If numberOfBeams is larger than or equal to
sumNumberOfTriggeringBeams
        6> Increment the triggeringBeamsCount by the number of beams
fulfilled the entry condition applicable for this event
      5 > else
        6 > Increment the triggeringBeamsCount by the number of beams
fulfilled the entry condition applicable for this event
        6 > If numberOfBeams is larger than or equal to
sumNumberOfTriggeringBeams
          7>
          7> initiate the measurement reporting procedure.
```

### Example Implementation of Adaptation of Entering Condition

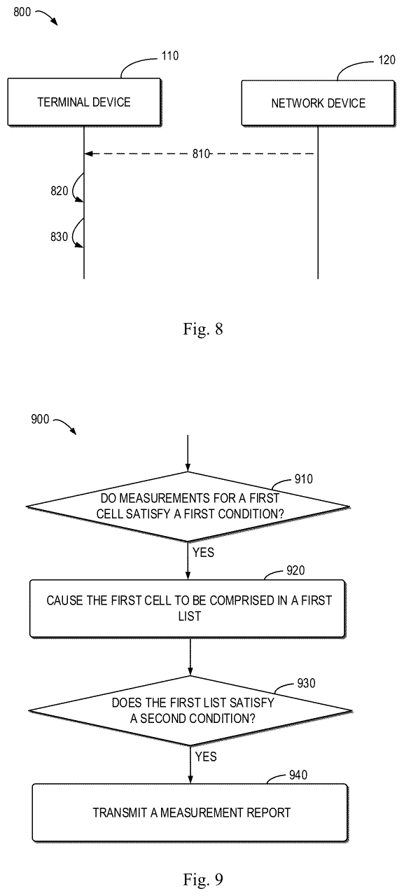

FIG. 8 illustrates a schematic diagram illustrating another process 800 of communication for a measurement reporting according to embodiments of the present disclosure. For the purpose of discussion, the process 800 will be described with reference to FIG. 1. The process 800 may involve the terminal device 110 and the network device 120 as illustrated in FIG. 1.

As shown in FIG. 8, the network device 120 may transmit 810 a measurement configuration to the terminal device 110. In some embodiments, the measurement configuration may comprise a height related offset (denoted as heightSpecificOffset herein). When a height of the terminal device 110 is higher than or equal to a predetermined height, the height related offset may be applied in an entering condition. In some embodiments, the measurement configuration may comprise a beam related offset (denoted as numberOfBeamsOffset herein). When the number of beams satisfying a predetermined quality condition in a cell is higher than or equal to a threshold number, the beam related offset may be applied in an entering condition. It is to be understood that the measurement configuration may also comprise any other suitable information.

In some embodiments, the entering condition of the measurement event is evaluated based on beam measurements. If N beams fulfilled the entering condition of this event, the terminal device 110 may add the corresponding cell in the cellsTriggeredList2. In some embodiments, if the number of cell(s) in the cellsTriggeredList2 is larger than or equal to numberOfTriggeringCells, the terminal device 110 may initiate a measurement report. In some embodiments, if the number of cell(s) in the cellsTriggeredList2 other than the corresponding cell is less than or equal to numberOfTriggeringCells and the number of cell(s) with the corresponding cell in the cellsTriggeredList2 is larger than or equal to numberOfTriggeringCells, the terminal device 110 may initiate a measurement report.

In some embodiments, the entering condition is evaluated based on beam measurements. If N beams fulfilled the entering condition of this event, and if these beams are from N1 cells based on cell ID (i.e., physical cell ID (PCI)) and N1 is equal to or larger than a threshold, the terminal device 110 may initiate a measurement report. With reference to FIG. 8, the terminal device 110 may determine 820 an entering condition (for convenience, also referred to as an eighth condition herein) based on at least one of beam measurements or a height of the terminal device 110.

In some embodiments, if the height of the terminal device 110 is higher than or equal to the predetermined height, the terminal device 110 may determine the eighth condition based on the height related offset.

In some embodiments, if a measurement report is triggered by a height event, the terminal device 110 may set the aerialStatus according to the triggered height event and determine the eighth condition based on the height related offset associated to the aerialStatus. For example, upon entering an event H1, the terminal device 110 may set the aerialStatus to 1. Upon entering an event H2, the terminal device 110 may set the aerialStatus to 2. Upon leaving the event H1 or the event H2, the terminal device 110 may set aerialStatus to 0. For aerialStatus 0, 1, and 2, the corresponding height related offset for the measurement event may be heightSpecificOffset0, heightSpecificOffset1 and heightSpecificOffset2.

For example, an example procedure may be described as below.

```
2> if the triggerType is set to event and if the eventId is set to eventH1 or eventH2 and if the
entering condition applicable for this event, i.e. the event corresponding with the eventId of
the corresponding reportConfig within VarMeasConfig, is fulfilled during timeToTrigger
defined within the VarMeasConfig for this event, while the VarMeasReportList does not
include a measurement reporting entry for this measId:
  3> include a measurement reporting entry within the VarMeasReportList for this measId;
  3> set the numberOfReportsSent defined within the VarMeasReportList for this measId
to 0;
  3> set the aerialStatus to 1 for eventH1 and 2 for eventH2
  3> initiate the measurement reporting procedure.
```

For example, an example event A4 may be described as below.

The UE shall:
1> consider the entering condition for this event to be satisfied when
condition A4-1, as specified below, is fulfilled;
1> consider the leaving condition for this event to be satisfied when
condition A4-2, as specified below, is fulfilled.
Inequality A4-1 (Entering condition)
Mn + offset value + heightSpecificOffset − Hys > Thresh
Inequality A4-2 (Leaving condition)
Mn + offset value + heightSpecificOffset + Hys < Thresh

The variables in the formula are defined as follows:
Mn is the measurement result of the neighbouring cell, not taking into account any offsets.
offset value is the sum of other offset values.
heightSpecificOffset is the height specific offset for this event. (i.e., consider the corresponding offset within reportConfigNR for this event according to aerialStatus)
Hys is the hysteresis parameter for this event (i.e. hysteresis as defined within reportConfigNR for this event).
Thresh is the threshold parameter for this event.

In some embodiments, if the number of beams satisfying the predetermined quality condition in a cell is higher than or equal to a threshold number (for convenience, also referred to as a second threshold number herein), the terminal device 110 may determine the eighth condition based on the beam related offset.

For example, an example event A4 may be described as below.

The UE shall:
1> consider the entering condition for this event to be satisfied when
condition A4-1, as specified below, is fulfilled;
1> consider the leaving condition for this event to be satisfied when
condition A4-2, as specified below, is fulfilled.
Inequality A4-1 (Entering condition)
Mn + offset value + numberOfBeamsOffset − Hys > Thresh
Inequality A4-2 (Leaving condition)
Mn + offset value + numberOfBeamsOffset + Hys < Thresh

The variables in the formula are defined as follows:
Mn is the measurement result of the neighbouring cell, not taking into account any offsets.
offset value is the sum of other offset values.
numberOfBeamsOffset is the offset considered when the number of beams with beam measurement quantity values above absThreshSS-BlocksConsolidation is equal to or larger than threshold.
Hys is the hysteresis parameter for this event (i.e. hysteresis as defined within reportConfigNR for this event).
Thresh is the threshold parameter for this event.

Continue to refer to FIG. 8, if measurements for a cell (for convenience, also referred to as a fourth cell herein) satisfy the eighth condition, the terminal device 110 may cause 830 the fourth cell to be comprised in a list (for convenience, also referred to as a fifth list herein) for triggering a measurement report.

In some embodiments, if the number of beams satisfying the eighth condition in the fourth cell is higher than or equal to a threshold number (for convenience, also referred to as a first threshold number herein), the terminal device 110 may determine that measurements for the fourth cell satisfies the eighth condition.

In this way, a frequent measurement reporting may also be avoided.

It is to be understood that solutions of Embodiments 1 to 11 described above may be carried out separately or in any suitable combination.

### Example Implementation of Methods

Accordingly, embodiments of the present disclosure provide methods of communication implemented at a terminal device and a network device. These methods will be described below with reference to FIGS. 9 to 12.

FIG. 9 illustrates an example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 determines whether measurements for a first cell satisfy a first condition. If the measurements for the first cell satisfy the first condition, the method 900 proceeds to block 920.

At block 920, the terminal device 110 causes the first cell to be comprised in a first list. That is, the terminal device 110 adds the first cell into the first list.

At block 930, the terminal device 110 determines whether the first list satisfies a second condition. The second condition is associated with a set of interested cells. If the first list satisfies the second condition, the method 900 proceeds to block 940.

At block 940, the terminal device 110 transmits a measurement report.

In some embodiments, if the first cell is indicated in the set of interested cells, the terminal device 110 may determine that the second condition is satisfied.

In some embodiments, if the number of cells in the first list is smaller than or equal to a first predetermined number and the first cell is indicated in the set of interested cells, the terminal device 110 may determine that the second condition is satisfied.

In some embodiments, if the number of cells in the first list other than the first cell is greater than or equal to a first predetermined number and the first cell is indicated in the set of interested cells, the terminal device 110 may determine that the second condition is satisfied.

In some embodiments, the terminal device 110 may determine weights of cells in the first list. If a sum of the weights of the cells in the first list is greater than or equal to a first predetermined value, the terminal device 110 may determine that the second condition is satisfied. In some additional embodiments, the terminal device 110 may determine that a sum of weights of cells in the first list other than the first cell is smaller than or equal to the first predetermined value. In some additional embodiments, if the second condition is satisfied, the terminal device 110 may reset the sum of the weights.

In some embodiments, if quality of the first cell is higher than or equal to quality of other cells in the first list, the terminal device 110 may determine that the second condition is satisfied.

In some embodiments, if the number of cells in the first list is smaller than or equal to a first predetermined number and quality of the first cell is higher than or equal to quality of other cells in the first list, the terminal device 110 may determine that the second condition is satisfied.

In some embodiments, if the number of cells in the first list other than the first cell is greater than or equal to a first predetermined number and quality of the first cell is higher than or equal to quality of other cells in the first list, the terminal device 110 may determine that the second condition is satisfied.

With the method 900, late measurement reporting may be avoided by considering a set of interested cells.

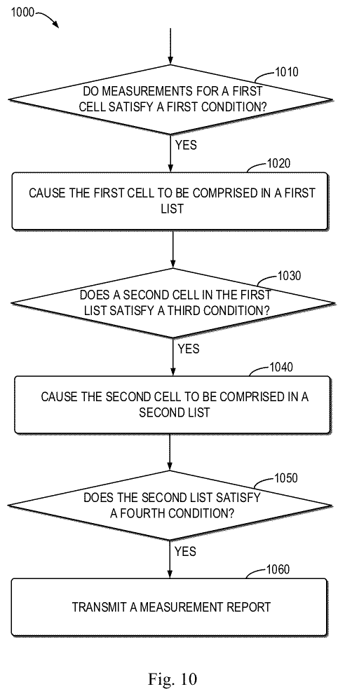

FIG. 10 illustrates another example method 1000 of communication implemented at a terminal device in accordance with some embodiments of the present disclosure. For example, the method 1000 may be performed at the terminal device 110 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the terminal device 110 determines whether measurements for a first cell satisfy a first condition. If the measurements for the first cell satisfy the first condition, the method 1000 proceeds to block 1020. At block 1020, the terminal device 110 causes the first cell to be comprised in a first list.

At block 1030, the terminal device 110 determines whether measurements for a second cell in the first list satisfy a third condition. If the measurements for the second cell in the first list satisfy the third condition, the method 1000 proceeds to block 1040. At block 1040, the terminal device 110 causes the second cell to be comprised in a second list.

At block 1050, the terminal device 110 determines whether the second list satisfies a fourth condition. If the second list satisfies the fourth condition, the method 1000 proceeds to block 1060. At block 1060, the terminal device 110 transmits a measurement report. In some embodiments, if the second list satisfies the fourth condition, the terminal device 110 may cause the second list to be empty.

In some embodiments, if the number of cells in the second list is greater than or equal to a second predetermined number, the terminal device 110 may determine that the fourth condition is satisfied.

In some embodiments, if the number of cells in the second list is greater than or equal to a second predetermined number and at least one cell in the second list has been reported in a previous measurement report, the terminal device 110 may determine that the fourth condition is satisfied.

In some embodiments, if the second cell has been reported in a previous measurement report, the terminal device 110 may determine that the third condition is satisfied.

In some embodiments, if the second list is empty, the terminal device 110 may start a timer upon addition of the second cell in the second list. In some additional embodiments, if the timer expires, the terminal device 110 may determine that the fourth condition is satisfied. In some additional embodiments, if the number of cells in the second list is greater than or equal to a second predetermined number and the timer is running, the terminal device 110 may determine that the fourth condition is satisfied.

In some embodiments, if the second cell is indicated in a set of interested cells, the terminal device 110 may determine that the fourth condition is satisfied.

In some embodiments, if the number of cells in the second list is smaller than or equal to a second predetermined number and the second cell is indicated in a set of interested cells, the terminal device 110 may determine that the fourth condition is satisfied.

In some embodiments, if the number of cells in the second list other than the second cell is greater than or equal to a second predetermined number and the second cell is indicated in a set of interested cells, the terminal device 110 may determine that the fourth condition is satisfied.

In some embodiments, the terminal device 110 may determine weights of cells in the second list. If a sum of the weights of the cells in the second list is greater than or equal to a second predetermined value, the terminal device 110 may determine that the fourth condition is satisfied. In some additional embodiments, the terminal device 110 may determine that a sum of weights of cells in the second list other than the second cell is smaller than or equal to the second predetermined value. In some additional embodiments, if the fourth condition is satisfied, the terminal device 110 may reset the sum of the weights.

In some embodiments, if quality of the second cell is worse than quality of other cells in the second list, the terminal device 110 may determine that the fourth condition is satisfied.

With the method 1000, a frequent measurement reporting due to report on leave may be avoided by considering a leaving cell list.

FIG. 11 illustrates another example method 1100 of communication implemented at a terminal device in accordance with some embodiments of the present disclosure. For example, the method 1100 may be performed at the terminal device 110 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the terminal device 110 determines whether measurements for a beam of a third cell satisfy a fifth condition. If the measurements for the beam of the third cell satisfy the fifth condition, the method 1100 proceeds to block 1120. At block 1120, the terminal device 110 causes the beam to be comprised in a third list.

At block 1130, the terminal device 110 determines whether the third list satisfies a sixth condition. If the third list satisfies a sixth condition, the method 1100 proceeds to block 1140. At block 1140, the terminal device 110 transmits a measurement report.

In some embodiments, if the number of beams of the third cell in the third list is greater than or equal to a third predetermined number, the terminal device 110 may determine that the third list satisfies the sixth condition. In some embodiments, if the number of beams in the third list is greater than or equal to a fourth predetermined number, the terminal device 110 may determine that the third list satisfies the sixth condition. In some additional embodiments, if the sixth condition is satisfied, the terminal device 110 may reset the number of beams in the third list.

In some embodiments, if measurements for the third cell satisfy a seventh condition, the terminal device 110 may cause the third cell to be comprised in a fourth list. If the number of cells in the fourth list is smaller than or equal to a fifth predetermined number and the number of beams in the third list is greater than or equal to a fourth predetermined number, the terminal device 110 may determine that the third list satisfies the sixth condition.

With the method 1100, a frequent measurement reporting may be avoided by considering beam measurements.

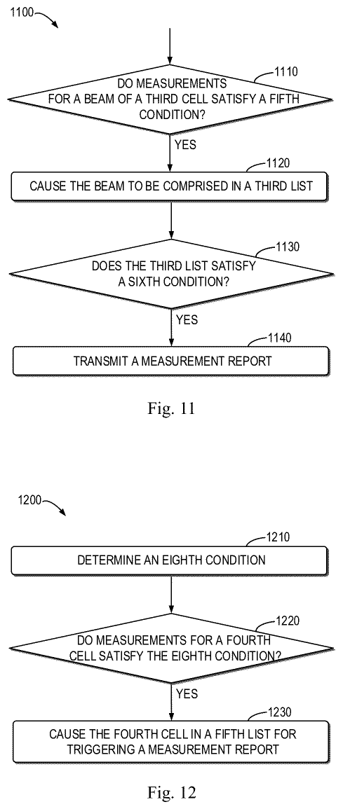

FIG. 12 illustrates another example method 1200 of communication implemented at a terminal device in accordance with some embodiments of the present disclosure. For example, the method 1200 may be performed at the terminal device 110 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

At block 1210, the terminal device 110 determines an eighth condition based on at least one of beam measurements or a height of the terminal device 110.

In some embodiments, the terminal device 110 may receive a measurement configuration comprising a height related offset. If the height of the terminal device 110 is higher than or equal to a predetermined height, the terminal device 110 may determine the eighth condition based on the height related offset.

In some embodiments, the terminal device 110 may receive a measurement configuration comprising a beam related offset. If the number of beams satisfying a predetermined quality condition in the fourth cell is higher than or equal to a second threshold number, the terminal device 110 may determine the eighth condition based on the beam related offset.

At block 1220, the terminal device 110 determines whether measurements for a fourth cell satisfy the eighth condition. In some embodiments where the eighth condition is associated with the beam measurements, if the number of beams satisfying the eighth condition in the fourth cell is higher than or equal to a first threshold number, the terminal device 110 may determine that measurements for the fourth cell satisfies the eighth condition.

If the measurements for the fourth cell satisfy the eighth condition, the method 1200 proceeds to block 1230. At block 1230, the terminal device 110 causes the fourth cell to be comprised in a fifth list for triggering a measurement report.

With the method 1200, a frequent measurement reporting may be avoided by adapting an entering condition.

### Example Implementation of Device and Apparatus

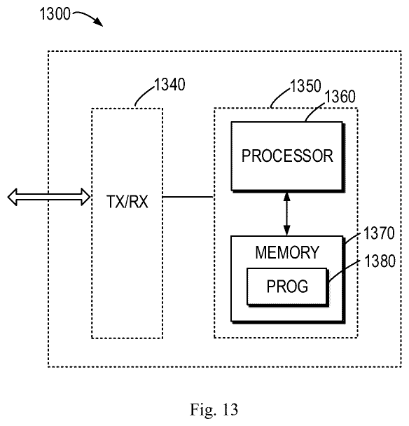

FIG. 13 is a simplified block diagram of a device 1300 that is suitable for implementing embodiments of the present disclosure. The device 1300 can be considered as a further example implementation of the terminal device 110 or the access network device 120 as shown in FIG. 1. Accordingly, the device 1300 can be implemented at or as at least a part of the terminal device 110, the access network device 120 or the AMF 131.

As shown, the device 1300 includes a processor 1310, a memory 1320 coupled to the processor 1310, a suitable transmitter (TX) and receiver (RX) 1340 coupled to the processor 1310, and a communication interface coupled to the TX/RX 1340. The memory 1310 stores at least a part of a program 1330. The TX/RX 1340 is for bidirectional communications. The TX/RX 1340 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1330 is assumed to include program instructions that, when executed by the associated processor 1310, enable the device 1300 to operate in accordance with the embodiments of the present disclosure, as discussed herein with reference to FIGS. 1 to 12. The embodiments herein may be implemented by computer software executable by the processor 1310 of the device 1300, or by hardware, or by a combination of software and hardware. The processor 1310 may be configured to implement various embodiments of the present disclosure. Furthermore, a combination of the processor 1310 and memory 1320 may form processing means 1350 adapted to implement various embodiments of the present disclosure.

The memory 1320 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1320 is shown in the device 1300, there may be several physically distinct memory modules in the device 1300. The processor 1310 may be of any type suitable to the local technical network, and may include one or more of general purpose computers, special purpose computers, microprocessors, digital signal processors (DSPs) and processors based on multicore processor architecture, as non-limiting examples. The device 1300 may have multiple processors, such as an application specific integrated circuit chip that is slaved in time to a clock which synchronizes the main processor.

In some embodiments, a terminal device comprises a circuitry configured to: in accordance with a determination that measurements for a first cell satisfy a first condition, causing, at a terminal device, the first cell to be comprised in a first list; and in accordance with a determination that the first list satisfies a second condition, transmitting a measurement report, the second condition being associated with a set of interested cells.

In some embodiments, a terminal device comprises a circuitry configured to: in accordance with a determination that measurements for a first cell satisfy a first condition, causing, at a terminal device, the first cell to be comprised in a first list; in accordance with a determination that measurements for a second cell in the first list satisfy a third condition, causing the second cell to be comprised in a second list; and in accordance with a determination that the second list satisfies a fourth condition, transmitting a measurement report.

In some embodiments, a terminal device comprises a circuitry configured to: in accordance with a determination that measurements for a beam of a third cell satisfy a fifth condition, causing, at a terminal device, the beam to be comprised in a third list; and in accordance with a determination that the third list satisfies a sixth condition, transmitting a measurement report.

In some embodiments, a terminal device comprises a circuitry configured to: determining, at a terminal device, an eighth condition based on at least one of beam measurements or a height of the terminal device; and in accordance with a determination that measurements for a fourth cell satisfy the eighth condition, causing the fourth cell to be comprised in a fifth list for triggering a measurement report.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: in accordance with a determination that measurements for a first cell satisfy a first condition, causing, at a terminal device, the first cell to be comprised in a first list; and in accordance with a determination that the first list satisfies a second condition, transmitting a measurement report, the second condition being associated with a set of interested cells.

In some embodiments, the method above further comprises at least one of the following: in accordance with a determination that the first cell is indicated in the set of interested cells, determining that the second condition is satisfied; in accordance with a determination that the number of cells in the first list is smaller than or equal to a first predetermined number and the first cell is indicated in the set of interested cells, determining that the second condition is satisfied; or in accordance with a determination that the number of cells in the first list other than the first cell is greater than or equal to a first predetermined number and the first cell is indicated in the set of interested cells, determining that the second condition is satisfied.

In some embodiments, the method above further comprises: determining weights of cells in the first list; and in accordance with a determination that a sum of the weights of the cells in the first list is greater than or equal to a first predetermined value, determining that the second condition is satisfied. In some embodiments, the method above further comprises: determining that a sum of weights of cells in the first list other than the first cell is smaller than or equal to the first predetermined value.

In some embodiments, the method above further comprises: in accordance with a determination that the second condition is satisfied, resetting the sum of the weights.

In some embodiments, the method above further comprises at least one of the following: in accordance with a determination that quality of the first cell is better than quality of other cells in the first list, determining that the second condition is satisfied; in accordance with a determination that the number of cells in the first list is smaller than or equal to a first predetermined number and quality of the first cell is higher than or equal to quality of other cells in the first list, determining that the second condition is satisfied; or in accordance with a determination that the number of cells in the first list other than the first cell is greater than or equal to a first predetermined number and quality of the first cell is higher than or equal to quality of other cells in the first list, determining that the second condition is satisfied.

In another solution, a method of communication comprises: in accordance with a determination that measurements for a first cell satisfy a first condition, causing, at a terminal device, the first cell to be comprised in a first list; in accordance with a determination that measurements for a second cell in the first list satisfy a third condition, causing the second cell to be comprised in a second list; and in accordance with a determination that the second list satisfies a fourth condition, transmitting a measurement report.

In some embodiments, the method above further comprises: in accordance with a determination that the number of cells in the second list is greater than or equal to a second predetermined number, determining that the fourth condition is satisfied; or in accordance with a determination that the number of cells in the second list is greater than or equal to a second predetermined number and at least one cell in the second list has been reported in a previous measurement report, determining that the fourth condition is satisfied.

In some embodiments, the method above further comprises: in accordance with a determination that the second cell has been reported in a previous measurement report, determining that the third condition is satisfied.

In some embodiments, the method above further comprises: in accordance with a determination that the second list satisfies the fourth condition, causing the second list to be empty.

In some embodiments, the method above further comprises: in accordance with a determination that the second list is empty, starting a timer upon addition of the second cell in the second list.

In some embodiments, the method above further comprises: in accordance with a determination that the timer expires, determining that the fourth condition is satisfied; or in accordance with a determination that the number of cells in the second list is greater than or equal to a second predetermined number and the timer is running, determining that the fourth condition is satisfied.

In some embodiments, the method above further comprises at least one of the following: in accordance with a determination that the second cell is indicated in a set of interested cells, determining that the fourth condition is satisfied; or in accordance with a determination that the number of cells in the second list is smaller than or equal to a second predetermined number and the second cell is indicated in a set of interested cells, determining that the fourth condition is satisfied; or in accordance with a determination that the number of cells in the second list other than the second cell is greater than or equal to a second predetermined number and the second cell is indicated in a set of interested cells, determining that the fourth condition is satisfied.

In some embodiments, the method above further comprises: determining weights of cells in the second list; and in accordance with a determination that a sum of the weights of the cells in the second list is greater than or equal to a second predetermined value, determining that the fourth condition is satisfied.

In some embodiments, the method above further comprises: determining that a sum of weights of cells in the second list other than the second cell is smaller than or equal to the second predetermined value.

In some embodiments, the method above further comprises: in accordance with a determination that the fourth condition is satisfied, resetting the sum of the weights.

In some embodiments, the method above further comprises: in accordance with a determination that quality of the second cell is worse than quality of other cells in the second list, determining that the fourth condition is satisfied.

In another solution, a method of communication comprises: in accordance with a determination that measurements for a beam of a third cell satisfy a fifth condition, causing, at a terminal device, the beam to be comprised in a third list; and in accordance with a determination that the third list satisfies a sixth condition, transmitting a measurement report.

In some embodiments, the method above further comprises: in accordance with a determination that the number of beams of the third cell in the third list is greater than or equal to a third predetermined number, determining that the third list satisfies the sixth condition; or in accordance with a determination that the number of beams in the third list is greater than or equal to a fourth predetermined number, determining that the third list satisfies the sixth condition.

In some embodiments, the method above further comprises: in accordance with a determination that the sixth condition is satisfied, resetting the number of beams in the third list.

In some embodiments, the method above further comprises: in accordance with a determination that measurements for the third cell satisfy a seventh condition, causing the third cell to be comprised in a fourth list; and in accordance with a determination that the number of cells in the fourth list is smaller than or equal to a fifth predetermined number and the number of beams in the third list is greater than or equal to a fourth predetermined number, determining that the third list satisfies the sixth condition.

In another solution, a method of communication comprises: determining, at a terminal device, an eighth condition based on at least one of beam measurements or a height of the terminal device; and in accordance with a determination that measurements for a fourth cell satisfy the eighth condition, causing the fourth cell to be comprised in a fifth list for triggering a measurement report.

In some embodiments, determining the eighth condition comprises: receiving a measurement configuration comprising a height related offset; and in accordance with a determination that the height of the terminal device is higher than or equal to a predetermined height, determining the eighth condition based on the height related offset.

In some embodiments, the eighth condition is associated with the beam measurements. In these embodiments, the method further comprises: in accordance with a determination that the number of beams satisfying the eighth condition in the fourth cell is higher than or equal to a first threshold number, determining that measurements for the fourth cell satisfies the eighth condition.

In some embodiments, determining the eighth condition comprises: receiving a measurement configuration comprising a beam related offset; and in accordance with a determination that the number of beams satisfying a predetermined quality condition in the fourth cell is higher than or equal to a second threshold number, determining the eighth condition based on the beam related offset.

In another solution, a device of communication comprises: a processor configured to perform the method according to any of the claims above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
receiving, from a network device, a measurement configuration; and
initiating a measurement reporting, based on the measurement configuration, in a case where:
a leaving condition is satisfied for a first cell, in one or more cells, included in a first cell list; and
at least one cell in the one or more cells has been reported in a previous measurement report.

22. The method of claim 21, before the initiating a measurement reporting, the method comprising:
including a second cell in the first cell list, in a case where an entering condition is satisfied for the second cell.

23. The method of claim 21, comprising:
removing the first cell from the first cell list, in a case where the leaving condition is satisfied for the first cell.

24. The method of claim 22, wherein
a number of cells in the first cell list without the second cell is greater than or equal to a predetermined number comprised in a report configuration.

25. The method of claim 21, comprising:
initiating the measurement reporting, in a case where a parameter of reportType is set to eventTriggered and a parameter of reportOnLeave is set to true.

26. A method, performed by a network device, the method comprising:
transmitting, to a terminal device, a measurement configuration; and
receiving a measurement reporting, based on the measurement configuration, in a case where:
a leaving condition is satisfied for a first cell, in one or more cells, included in a first cell list; and
at least one cell in the one or more cells has been reported in a previous measurement report.

27. The method of claim 26, before the receiving a measurement reporting, the method comprising:
including a second cell in the first cell list, in a case where an entering condition is satisfied for the second cell.

28. The method of claim 26, comprising:
removing the first cell from the first cell list, in a case where the leaving condition is satisfied for the first cell.

29. The method of claim 27, wherein
a number of cells in the first cell list without the second cell is greater than or equal to a predetermined number comprised in a report configuration.

30. The method of claim 26, comprising:
receiving the measurement reporting, in a case where a parameter of reportType is set to eventTriggered and a parameter of reportOnLeave is set to true.

31. A terminal device, comprising a processor configured to cause the terminal device to:
receive, from a network device, a measurement configuration; and
initiate a measurement reporting, based on the measurement configuration, in a case where:
a leaving condition is satisfied for a first cell, in one or more cells, included in a first cell list; and
at least one cell in the one or more cells has been reported in a previous measurement report.

32. The terminal device of claim 31, wherein, before the initiating a measurement reporting, the processor is configured to cause the terminal device to:
include a second cell in the first cell list, in a case where an entering condition is satisfied for the second cell.

33. The terminal device of claim 31, wherein the processor is configured to cause the terminal device to:
remove the first cell from the first cell list, in a case where the leaving condition is satisfied for the first cell.

34. The terminal device of claim 32, wherein
a number of cells in the first cell list without the second cell is greater than or equal to a predetermined number comprised in a report configuration.

35. The terminal device of claim 31, wherein the processor is configured to cause the terminal device to:
initiate the measurement reporting, in a case where a parameter of reportType is set to eventTriggered and a parameter of reportOnLeave is set to true.
